(19) United States
(12) Patent Application Publication
(10) Pub. No.: US 2021/0407283 A1
(43) Pub. Date: Dec. 30, 2021

(54) SERVER DEVICE, TRAVEL MANAGEMENT METHOD, NON-TRANSITORY COMPUTER-READABLE MEDIUM, AND AUTOMOTIVE DEVICE

(71) Applicant: PANASONIC INTELLECTUAL PROPERTY MANAGEMENT CO., LTD., Osaka (JP)

(72) Inventors: Yukihiro TOYOKITA, Osaka (JP); Fumio KOSUGE, Tokyo (JP)

(73) Assignee: PANASONIC INTELLECTUAL PROPERTY MANAGEMENT CO., LTD., Osaka (JP)

(21) Appl. No.: 17/474,856

(22) Filed: Sep. 14, 2021

Related U.S. Application Data
(63) Continuation of application No. PCT/JP2020/005915, filed on Feb. 14, 2020.

(30) Foreign Application Priority Data
Mar. 15, 2019 (JP) 2019-048931

(51) Int. Cl. G08G 1/01; G08G 1/015; H04L 29/08; G06Q 30/02; G06Q 50/30

(52) U.S. Cl. CPC G08G 1/0125; G08G 1/015; G06Q 50/30; G06Q 30/0284; H04L 67/12

(57) ABSTRACT

A server device includes a receiver and a processor. The receiver is configured to receive lane state/vehicle position information of an idle lane via a first communication network. The receiver is configured to receive own-vehicle position information of a vehicle via a second communication network. The receiver is configured to receive a travel request for the idle lane from the vehicle via a third communication network. In response to the travel request, the processor determines whether traveling in the idle lane is available to the vehicle, based on the own-vehicle position information of the vehicle and the lane state/vehicle position information of the idle lane.

### CROSS-REFERENCE TO RELATED APPLICATIONS

This application is a continuation of PCT International Patent Application No. PCT/JP2020/005915 filed on Feb. 14, 2020, which claims the benefit of priority of Japanese Patent Application No. 2019-048931 filed on Mar. 15, 2019, the entire contents of which are incorporated herein by reference.

### FIELD

The present disclosure relates to a server device that manages idle lane travel of a vehicle.

In addition, the present disclosure also relates to a management method, a travel management program, and an in-vehicle terminal that manage idle lane travel of a vehicle.

### BACKGROUND

JP-A-2008-262418 discloses a congestion alleviation system, a ground system, and a congestion prediction control device that control traffic at the time of lane change and alleviate congestion at the time of passage of a narrow path, in view of a fact that congestion is likely to occur at a narrow path.

In the congestion alleviation system disclosed in JP-A-2008-262418, the ground system includes: a first identification information acquisition unit that acquires identification information of a vehicle passing through a predetermined portion; a first passage time-point acquisition unit that acquires a first passage time-point of passing through the predetermined portion; a second identification information acquisition unit that acquires identification information of a vehicle passing through a narrow path; a second passage time-point acquisition unit that acquires a second passage time-point of passing through the narrow path; a congestion calculation control unit that determines priority for each vehicle to pass through the narrow path based on a first acquisition time-point; and a transmission device that transmits the priority to each vehicle. The congestion prediction control device includes a reception device that receives the priority and a notification device that notifies an occupant of the priority.

### SUMMARY

A usage rate of a road is not necessarily 100%. For example, in a certain time period, vehicles are concentrated in a certain traveling lane (lane) of a certain road. However, in another time period, a lane in which the vehicles can travel may be left. In addition, depending on the condition, lanes in which the vehicles can travel may exist separately even in the same time.

A road is an infrastructure and is social capital. Capital is preferred to be used. Here, in the present disclosure, a lane, which a general vehicle can physically travel in but is not permitted and which is not actually used, is referred to as an “idle lane”. Then, if it is possible to further utilize the idle lane, an occupant of a vehicle can avoid congestion.

The present disclosure has been made from such a viewpoint, and an object thereof is to effectively utilize an idle lane.

The present disclosure provides a server device including: a receiver; and a processor, wherein the receiver is configured to receive lane state/vehicle position information of an idle lane via a first communication network, wherein the receiver is configured to receive own-vehicle position information of a vehicle via a second communication network, wherein the receiver is configured to receive a travel request for the idle lane from the vehicle via a third communication network, and wherein in response to the travel request, the processor determines whether traveling in the idle lane is available to the vehicle, based on the own-vehicle position information of the vehicle and the lane state/vehicle position information of the idle lane.

The present disclosure provides a travel management method in a server device for managing idle lane travel of a vehicle, the server device including a receiver and a processor, the travel management method including: receiving, by the receiver, lane state/vehicle position information of an idle lane via a communication network; receiving, by the receiver, own-vehicle position information of a vehicle via a communication network; receiving, by the receiver, a travel request for the idle lane from the vehicle via a communication network; and causing, in response to the travel request, the processor to determine whether traveling in the idle lane is available to the vehicle, based on the own-vehicle position information of the vehicle and the lane state/vehicle position information of the idle lane.

The present disclosure provides a non-transitory computer-readable medium storing a travel management program for managing idle lane travel of a vehicle, the travel management program that, when executed by a processor of a server device including a receiver and the processor, causes the server device to perform operations including: receiving lane state/vehicle position information of an idle lane via a communication network; receiving own-vehicle position information of a vehicle via a communication network; receiving a travel request for the idle lane from the vehicle via a communication network; and determining, in response to the travel request, whether traveling in the idle lane is available to the vehicle, based on the own-vehicle position information of the vehicle and the lane state/vehicle position information of the idle lane.

The present disclosure provides automotive device to be mounted on a vehicle, the automotive device including: a receiver; and an output device, wherein in a case in which the receiver receives travel proposal information for an idle lane via a communication network, the output device outputs the travel proposal information for the idle lane to an occupant of the vehicle.

### BRIEF DESCRIPTION OF DRAWINGS

FIG. 1 is a conceptual diagram illustrating an idle lane 103.

FIG. 2 is a system configuration diagram illustrating an embodiment of an idle lane management system.

FIG. 3 is a diagram illustrating an example of travel proposal information output by an output unit 111.

FIGS. 4A and 4B are diagrams illustrating an example of travel permission/non-permission information output by the output unit 111 to an occupant, in which FIG. 4A illustrates a case of permission, and FIG. 4B illustrates a case of non-permission.

FIG. 5 is a flowchart illustrating an example of processing performed by a vehicle 1 and a server device 2 in a case where an occupant of the vehicle 1 requests to travel in the idle lane 103.

FIG. 6 is a diagram illustrating an output example of information indicating an end of travel by the output unit 111.

FIG. 7 is a diagram illustrating an example of output of fee-charging information by the output unit 111.

### DETAILED DESCRIPTION

Hereinafter, a description will be made in detail with reference to the drawings as appropriate on a premise that a vehicle is a network connected automobile (connected car). Such an automobile may be an autonomous automobile. Note that the accompanying drawings and the following description are provided for a thorough understanding of the present disclosure by those skilled in the art, and are not intended to limit the subject matter recited in the claims.

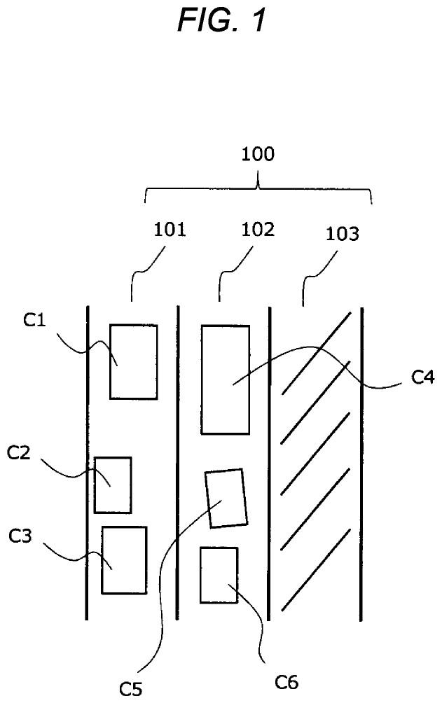

FIG. 1 is a conceptual diagram illustrating an idle lane 103. As illustrated, a roadway 100 may include a plurality of lanes 101, 102, and 103. Vehicles C1 to C6 travel in the normal lanes 101 and 102, respectively. However, as illustrated, congestion occurs in the roadway 100.

The vehicles C1 to C6 can appropriately change lanes by, for example, blinking left or right direction indicators. However, the vehicles are not traveling in the idle lane 103 for some reason.

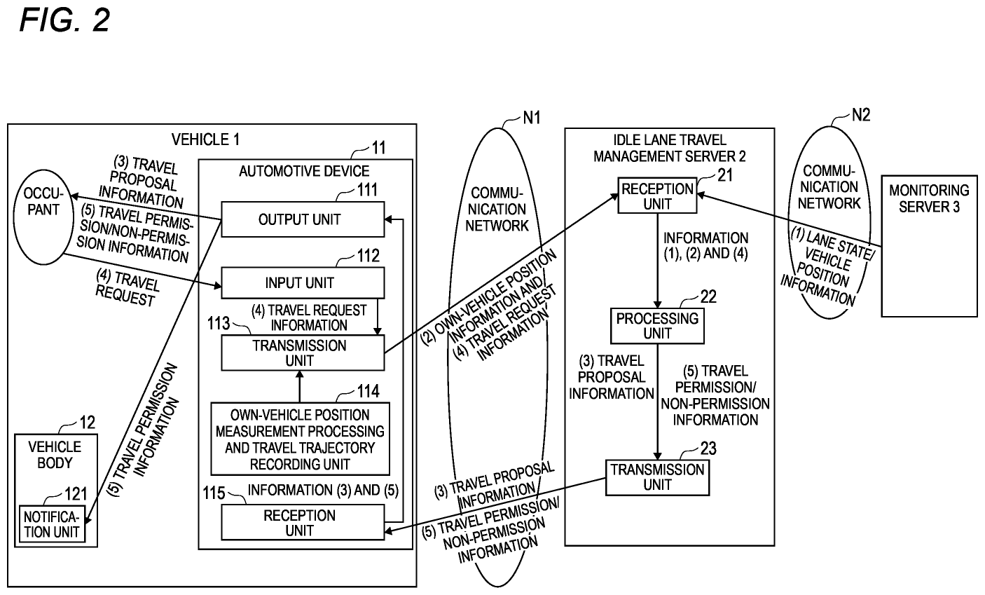

In such a condition, an idle lane travel management server device 2 of the present disclosure, which will be described later with reference to FIG. 2, can manage the idle lane 103 as follows, for example. Hereinafter, the idle lane travel management server device 2 may be abbreviated as a “server device 2”.

FIG. 2 is a system configuration diagram illustrating an embodiment of an idle lane management system that includes the server device 2 of the present disclosure and a vehicle 1 connected to the server device 2.

Before describing each type of information processing, each functional block of the vehicle 1 and the server device 2 will be described. Note that a functional block configuration in the vehicle 1 and a functional block configuration in the server device 2 may be other modes.

First, the vehicle 1 will be described. The vehicle 1 is an automobile corresponding to the vehicles C1 to C6 illustrated in FIG. 1. The vehicle 1 can communicate with the server device 2 via a communication network N1. The vehicle 1 includes an automotive device 11 and a vehicle body 12. The vehicle body 12 is a main body of the vehicle 1, and in general, the automotive device 11 is installed in the vehicle body 12. A notification unit 121 provided in the vehicle body 12 will be described later.

The automotive device 11 is a terminal or a terminal group provided in the vehicle 1, and includes an output unit 111, an input unit 112, a transmission unit 113, an own-vehicle position measurement processing and travel trajectory recording unit 114, and a reception unit 115. Note that other functional blocks may be provided. In addition, a plurality of functional blocks may be implemented with the same hardware resource. For example, the functions may be aggregated by using a CPU, a memory, or the like. Conversely, a plurality of functional blocks may be implemented by connecting a plurality of hardware resources with one another. The automotive device 11 may be, for example, an ECU connected to a car navigation system provided on a front panel of the vehicle 1.

The output unit 111 outputs some kind of information to an occupant riding in the vehicle 1. The output unit 111 may output visual information or output audio information.

The output unit 111 may output information other than visual information and audio information. The output unit 111 may typically be a monitor device or the like provided on a front panel of the vehicle 1. The automotive device 11 may be integrated with the car navigation system described above, and the output unit 111 may be a touch panel screen provided in the car navigation system. However, the hardware configuration is not limited thereto.

The input unit 112 receives some kind of information input from the occupant riding in the vehicle 1. The input unit 112 may be, for example, the touch panel screen described above, microphone input, or the like, and is not limited thereto.

When the occupant is driving the vehicle 1, the output unit 111 may output a sound, and the input unit 112 may receive a microphone input. When the vehicle 1 is stopped, the output unit 111 may output visual information, and the input unit 112 may receive a touch panel operation.

The transmission unit 113 transmits information to the outside via the communication network N1. The communication network N1 may be a mobile phone network. However, it is no intended to exclude other communication networks such as an IP network. Although a destination to which the information is transmitted from the transmission unit 113 is typically the server device 2, in vehicle-to-vehicle communication performed between a vehicle and another vehicle, a vehicle different from the vehicle 1 may be the transmission destination. The transmission unit 113 may include a communication interface or may be connected to a communication interface.

The own-vehicle position measurement processing and travel trajectory recording unit 114 include a sensor that acquires position information of the vehicle 1, and the sensor identifies an own-vehicle position of the vehicle 1 and records a travel trajectory of the vehicle 1. However, a type of the sensor is not particularly limited, and, for example, the position information may be acquired by GPS. The sensor may acquire the position by using other methods. The sensor may acquire other types of information such as a speed of the vehicle 1. A typical example of the own-vehicle position measurement processing and travel trajectory recording unit 114 is an in-vehicle probe.

The reception unit 115 is a functional block that receives information from the outside via the above-described communication network N1. A transmission source of the information may be the server device 2, another vehicle, or the like, similarly to the transmission destination of information. The reception unit 115 may include a communication interface or may be connected to a communication interface.

Although not illustrated, the automotive device 11 may include a processing unit because the automotive device 11 is a device that performs information processing. The processing unit may control each functional block in the vehicle 1 illustrated in FIG. 2.

Next, the notification unit 121 provided in the vehicle body 12 of the vehicle 1 will be described. The output unit 111 provided in the automotive device 11 outputs information to the notification unit 121 provided in the vehicle body 12 in addition to outputting information to the occupant riding in the vehicle 1. The notification unit 121 provided in the vehicle body 12 is for mainly notifying another person who is not riding in the vehicle 1 of information. For example, when the vehicle 1 is the vehicle C5 illustrated in FIG. 1, the notification unit 121 notifies the other vehicles C1 to C4 and C6 of information.

A notification mode of the notification unit 121 is typically display of visual information. For example, the notification unit 121 notifies the outside of the vehicle 1 of information by a method such as turning on or blinking a lamp provided on an outer side of the vehicle body 12 and displaying information on an electric bulletin board of the vehicle body. The notification unit 121 may perform notification by a notification method such as changing a color of the vehicle body 12 from an original color of the vehicle body to another color. The notification unit 121 may perform notification of information using sound by a speaker. In an environment where vehicle-to-vehicle communication can be performed, the notification unit 121 may perform notification of only information through vehicle-to-vehicle communication. Another vehicle that receives the notification information can notify an occupant of the other vehicle, for example, by devices such as a monitor provided in the front panel.

Next, a configuration example of the server device 2 side will be described. In this example, the server device 2 includes a reception unit 21, a processing unit 22, and a transmission unit 23. The server device 2 may further include other components. A plurality of functional blocks may be implemented with the same hardware resource. A plurality of functional blocks may be implemented by connecting a plurality of hardware resources with one another.

The reception unit 21 receives information from the outside via communication networks N1 and N2 and the like. A transmission source of the information may be the vehicle 1, a monitoring server device 3 to be described later, or the like. The reception unit 21 may include a communication interface or may be connected to a communication interface.

The communication network N2 is a network similar to the communication network N1 described above. The communication network N1 and the communication network N2 may be the same network or different networks. In addition, a system configuration may be provided in which a function of the monitoring server device 3 is provided in the server device 2, and in this case, there is no need to interpose the communication network N2.

The processing unit 22 performs determination (information processing) by using various types of information received from the reception unit 21, information stored in a storage unit (not illustrated), and the like. Information processing other than determination of travel permission/non-permission to be described later may be performed by the processing unit 22. The processing unit 22 may control the information processing of the server device 2. As a hardware resource, the processing unit 22 may be implemented with a CPU or the like. However, a configuration thereof is not limited thereto.

The transmission unit 23 is a functional block that transmits information to the outside via the communication network N1. However, information may be transmitted via another communication network. A destination to which information is transmitted from the transmission unit 23 is typically the vehicle 1, but is not limited thereto. The transmission unit 23 may include a communication interface or may be connected to a communication interface.

Although not illustrated, the server device 2 may include a storage unit. Information to be held by the server device 2 and various types of information received by the server device 2 from the outside is stored in the storage unit, and the processing unit 22 performs determination (information processing) using the information as necessary. A typical example of the processing unit 22 is a CPU or the like, but the present disclosure is not limited thereto. The storage unit of the server device 2 may store a travel management program for causing the server device 2 to execute various types of processing described later.

As an example, the server device 2 may be a blade server, a tower server, or the like having the above-described functions mounted on a server rack of a data center owned by a road administrator, but is not limited thereto.

Next, the monitoring server device 3 will be described. The monitoring server device 3 is a server that aggregates and controls various types of information indicating a state of a lane, a position of a vehicle traveling in a lane, and the like. The monitoring server device 3 may receive, from an external entity (not illustrated), congestion information indicating a congestion degree of a lane, information on a vehicle traveling in the lane (a current position of the vehicle, a vehicle type, and the like), and the like, and may store the information. The monitoring server device 3 may receive and store information on an emergency vehicle traveling in a lane and the like. In addition, the monitoring server device 3 may receive and store information indicating that an object, such as a fallen tree, that hinders passage of a vehicle is present. The above-described information received and stored by the monitoring server device 3 is described as “lane state/vehicle position information” in this example.

Although the system configuration illustrated in FIG. 2 is described above, the system configuration described above is merely an example, and it is not intended to exclude other system configurations.

Next, an example of processing related to management of the idle lane 103 based on the above-described system configuration will be described with reference to FIG. 2. For the sake of convenience, numbers (1) to (5) are assigned to different types of information. However, the information is not necessarily processed in an order of the numbers.

(1) Lane State/Vehicle Position Information

The server device 2 receives (1) lane state/vehicle position information from the monitoring server device 3. The lane state/vehicle position information is transmitted to the processing unit 22 via the reception unit 21 of the server device 2, and is used for determination of travel permission/non-permission, which will be described later, or the like. Note that the information received by the processing unit 22 and information generated by the processing unit 22 based on the received information may be stored in a storage unit or the like (not illustrated) of the server device 2. The processing unit 22 may appropriately use the stored information to perform each type of information processing.

Reception of the lane state/vehicle position information by the server device 2 may be performed steadily at regular time intervals, and may be performed at any time in response to an inquiry from the server device 2 to the monitoring server device 3.

(2) Own-Vehicle Position Information

A current position and the like of the vehicle 1 can be acquired by the own-vehicle position measurement processing and travel trajectory recording unit 114 provided in the vehicle 1. The own-vehicle position information acquired by the own-vehicle position measurement processing and travel trajectory recording unit 114 is transmitted to the server device 2 via the communication network N1, and the reception unit 21 of the server device 2 receives the information. Note that the information transmission and reception may be performed steadily, and the reception may be performed at any time in response to an inquiry from the server device 2 to the vehicle 1.

The own-vehicle position information of the vehicle 1 received by the reception unit 21 of the server device 2 is transmitted to the processing unit 22, and is used for determination of travel permission/non-permission, which will be described later, and the like. The information may be stored in a storage unit or the like (not illustrated) of the server device 2. The processing unit 22 may appropriately use the stored information to perform each type of information processing.

In order to make it possible to identify a vehicle (vehicle 1) that is a transmission source of information, for example, vehicle ID information or the like may be contained in the own-vehicle position information.

[Determination of Travel Permission/Non-Permission by the Processing Unit 22]

The processing unit 22 of the server device 2 determines whether the idle lane 103 is available for the vehicle 1, based on the above-described (1) lane state/vehicle position information and (2) own-vehicle position information. That is, the processing unit 22 performs determination of travel permission/non-permission. A trigger event for causing the determination processing of travel permission/non-permission may be reception of (1) lane state/vehicle position information or reception of (2) own-vehicle position information.

As described above, the monitoring server device 3 monitors lane information and the like, and stores information. Therefore, information indicating which lane is congested may be contained in (1) lane state/own-vehicle position information. That is, the server device 2 that receives (1) lane state/vehicle position information can identify a lane under congestion. With respect to a vehicle traveling in the lane under congestion, the processing unit 22 can start the determination processing of travel permission/non-permission.

In (2) own-vehicle position information, position information acquired by a probe (own-vehicle position measurement processing and travel trajectory recording unit 114) or the like provided in the vehicle 1, and speed information of the vehicle 1 may be contained. Therefore, the processing unit 22 that acquires (2) own-vehicle position information via the reception unit 21 can determine whether the vehicle 1 is in congestion based on the position and the speed of the vehicle 1. As a specific example, when traveling at a speed of 5 km/h or less continues for five minutes or more is detected based on probe data of the vehicle 1, the processing unit 22 can determine that the vehicle 1 is in congestion. In such a case, the processing unit 22 can start the determination processing of travel permission/non-permission for the vehicle 1.

In addition, for example, an occupant of the vehicle 1 may visually confirm occurrence of congestion. As a specific example, a congestion notification button (not illustrated) is provided in the automotive device 11. The occupant of the vehicle 1 who visually confirms the congestion pushes the congestion notification button, thereby transmitting a notification indicating congestion to the server device 2. By using reception of the notification as a trigger event, the processing unit 22 can start the determination processing of travel permission/non-permission.

Various determination algorithms to be used by the processing unit 22 of the server device 2 may be assumed. For example, a current position of the vehicle 1 may be identified based on (2) own-vehicle position information, and it may be determined whether a lane that is present near the current position is the idle lane 103 available for the vehicle 1, based on (1) lane state/vehicle position information.

Here, (1) lane state/vehicle position information received from the monitoring server device 3 may contain, for example, the following types of information A to C.

(Information A) Information on an object that is present in a lane and hinders vehicle passage.

(Information B) Travel information of an emergency vehicle or the like on a lane.

(Information C) Information indicating a type of vehicle for which a lane is available.

Regarding the information A, an object that hinders vehicle passage is, for example, an obstacle such as a fallen tree, an evacuated vehicle, or the like. The “evacuated vehicle” refers to a vehicle that has to be evacuated to an idle lane due to a vehicle failure, an accident, a poor physical condition of an occupant, or the like. In a case where such an obstacle or an evacuated vehicle is present on the idle lane, the vehicle 1 cannot travel in the idle lane because the idle lane is blocked by the object. Therefore, when the received (1) lane state/vehicle position information contains the information A, the processing unit 22 determines that traveling is not permitted for the vehicle 1.

Regarding the information B, an emergency vehicle such as an ambulance may travel in an idle lane. Here, as described above, the travel information of the emergency vehicle may be contained in (1) lane state/vehicle position information. When the received (1) lane state/vehicle position information contains the information B, the processing unit 22 determines that traveling is not permitted for the vehicle 1.

In order to prioritize passage of the emergency vehicle, the server device 2 may transmit, to the vehicle 1 that is already permitted to travel, (5) travel non-permission information indicating travel non-permission that will be described later.

Regarding the information C, a width of an idle lane may be too narrow for a vehicle to pass. Therefore, the information C indicating a type of vehicle (large, medium, small, vehicles complying with environmental regulations, or the like) for which the idle lane is available may be contained in (1) lane state/vehicle position information. Therefore, when the received (1) lane state/vehicle position information contains the information C, the processing unit 22 determines whether the vehicle 1 belongs to the type of vehicle indicated by the information C. When the vehicle 1 does not belong to the type of vehicle indicated by the information C, the processing unit 22 determines that traveling is not permitted for the vehicle 1.

Note that information indicating a type of the vehicle 1 may be identified by the processing unit 22 based on the vehicle ID information or the like in (2) own-vehicle position information. However, the present disclosure is not limited to this type identification method.

(3) Travel Proposal Information

For example, the processing unit 22 performs determination that is the above-described information processing of travel permission/non-permission. Then, when it is determined that the idle lane 103 is available for the vehicle 1, the server device 2 transmits (3) travel proposal information from the transmission unit 23 to the vehicle 1.

The travel proposal information may contain various types of information such as an ID of the vehicle 1, a lane ID of the idle lane 103 that is available, an allowed travel distance/travel time, a fee required for travel, a fee-charging method (in a case where fee charging occurs), and the like. Note that the travel proposal information may contain information other than the exemplified information.

When the reception unit 115 of the vehicle 1 receives (3) travel proposal information, the information is output to an occupant by the output unit 111. At the time of this output, conversion of a format or a display format may be performed as appropriate.

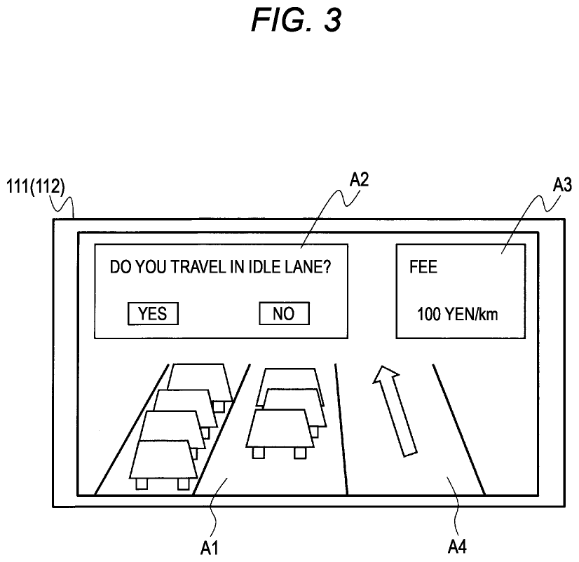

Here, FIG. 3 will be referred to. FIG. 3 is a diagram illustrating an example of travel proposal information that the output unit 111 outputs to an occupant based on travel proposal information received by the vehicle 1.

In the example illustrated in FIG. 3, a touch panel screen of a car navigation system is used as the output unit 111 also serving as the input unit 112. A message box A2 is output (displayed) in a manner of being superimposed on route information A1. In the message box A2, two buttons “YES” and “NO” are displayed side by side in a left and right direction together with a text message of “Do you travel in the idle lane?”. In addition, on the upper right of the screen, a fee display portion A3 indicating a fee required when the vehicle travels in the idle lane 103 is displayed (in a case where fee charging is performed). A4 is the idle lane 103, which is highlighted, and an arrow indicating a course is displayed. Note that this user interface is an example, and the travel proposal information may be output in other forms. For example, a travel proposal may be made to the occupant by audio output.

(4) Travel Request Information

Reference is made to FIGS. 2 and 3. The occupant of the vehicle 1 taps the “Yes” button. Then, a request to travel of the occupant is input to the input unit 112 (the touch panel screen in this example). Then, the automotive device 11 transmits the travel request information to the server device 2 via the transmission unit 113. The travel request information may contain, for example, the vehicle ID of the vehicle 1, the lane ID of the idle lane 103 to be traveled in, generation time-point information of the travel request information, and the like. Attribute information related to the vehicle 1, such as a vehicle type of the vehicle 1, may be contained in the travel request information. The travel request information may contain (2) own-vehicle position information so as to be transmitted collectively. In addition, information other than these types of information may be contained in the travel request information.

The travel request information reaches the processing unit 22 via the reception unit 21 of the server device 2. The processing unit 22 again determines, based on the travel request information, whether to permit the vehicle 1 to travel in the idle lane 103.

(5) Travel Permission/Non-Permission Information

The processing unit 22 determines, based on the obtained (1) lane state/vehicle position information, (2) own-vehicle position information, (4) travel request information, and the like, whether to permit the vehicle 1 to travel in the idle lane 103. Although this determination is substantially the same as that described above in the [Determination of Travel Permission/Non-Permission by the Processing Unit 22], there are also differences as follows.

There is a time difference between time at which the processing unit 22 transmits (3) travel proposal information to the vehicle 1 and time at which (4) travel request information is received. In fact, a condition of an external environment may change during a period from when the occupant of the vehicle 1 receives an output from the output unit 111 to when the occupant taps the “Yes” button described above. For example, a position of the vehicle 1 may change since the vehicle 1 travels forward. In addition, situations may occur such as one where the number of other vehicles to start traveling in the idle lane 103 like the vehicle 1 exceeds a fixed threshold, an emergency vehicle starts to travel in the idle lane 103, or a fallen tree newly appears and blocks the lane 103.

Therefore, the processing unit 22 of the server device 2 may perform the determination of travel permission/non-permission based on the information (1), (2), (4), or the like that is further updated since the time at which (3) travel proposal information is transmitted and that can be acquired at a current time-point.

Subsequently, the server device 2 transmits (5) travel permission/non-permission information indicating travel permission or travel non-permission to the vehicle 1 via the transmission unit 23, based on a determination result of the determination processing of travel permission/non-permission.

The automotive device 11 of the vehicle 1, which receives the travel permission/non-permission information by the reception unit 115, can perform two types of output. A first is output to an occupant of the vehicle 1, and a second is notification to a person other than the occupant of the vehicle 1. Hereinafter, these two types of output will be described.

First, the output to an occupant of the vehicle 1 will be described. The travel permission/non-permission information is transmitted from the reception unit 115 to the output unit 111, and the information is output toward the occupant by the output unit 111. At the time of outputting the information, the conversion of a format or a display format may be performed as appropriate. Note that an output format is not limited to visual information, and, for example, the output format may include audio information and the like, similarly to the output of (3) travel proposal information described above.

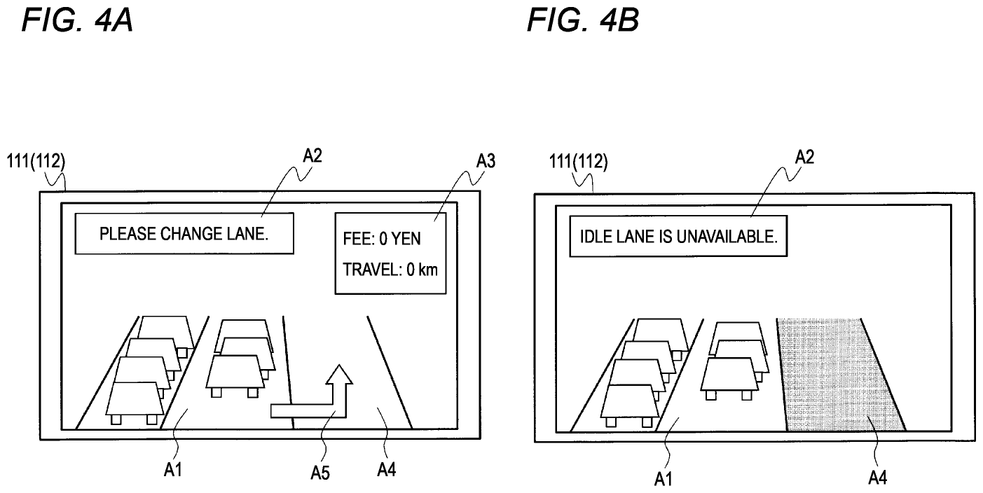

Here, reference is made to FIGS. 4A and 4B. FIGS. 4A and 4B are diagrams illustrating an example of travel permission/non-permission information that the output unit 111 outputs to an occupant based on travel permission/non-permission information received by the vehicle 1.

Also in the example illustrated in FIGS. 4A and 4B, a touch panel screen of a car navigation system is used as the output unit 111 and the input unit 112. FIG. 4A illustrates a case of permission, and FIG. 4B illustrates a case of non-permission.

In the case of permission illustrated in FIG. 4A, the message box A2 is displayed in a manner of being superimposed on the route information A1. In the message box A2, a text message of “Please change lane” is displayed. In the fee display portion A3 on the upper right of the screen, a fee required for traveling in the idle lane 103 is displayed (in a case where fee charging is performed). For example, in a case where a fee structure is pay-as-you-go fee-charging of 100 yen per 1 km of travel, a cumulative travel distance in the idle lane 103 (0 km at the time-point of FIG. 4A) may be displayed in parallel with a cumulative fee at a current time-point (0 yen at the time-point of FIG. 4A). The idle lane 103 indicated by A4 is displayed in a blinking manner. Further, an arrow A5 indicating that a lane change should be made from a lane in which the vehicle 1 is currently present to the adjacent idle lane 103 on a right side is displayed in a superimposed manner. Note that this user interface is an example, and travel permission information may be output in other forms. For example, the travel permission information may be output by voice narration such as “Please travel in the right lane. The fee is XX yen”. In a case where the vehicle 1 is an autonomous driving vehicle, the message box A2 may display a text message of “This vehicle will travel in the idle lane. The lane will be changed to the right lane”.

In the case of non-permission illustrated in FIG. 4B, the message box A2 superimposed on the route information A1 displays a text message of “The idle lane is unavailable”. Nothing is displayed at the fee display portion A3 on the upper right of the screen. The idle lane 103 indicated by A4 is subjected to neither highlight display nor blinking display, but is displayed in a gray color indicating travel non-permission. The arrow A5 is not displayed. Note that this user interface is an example, and travel non-permission information may be output in other forms. For example, the travel non-permission information may be output by voice narration such as “The idle lane is unavailable”.

As described above, the automotive device 11 that receives the travel permission/non-permission information by the reception unit 115 performs information output to the occupant of the vehicle 1 by the output unit 111. Next, the notification to a person other than the occupant of the vehicle 1 will be described.

As illustrated in FIG. 2, the travel permission information is transmitted from the output unit 111 to the notification unit 121 of the vehicle body 12. Upon receiving the permission information, the notification unit 121 of the vehicle body 12 performs notification for a person who is outside the vehicle 1 and who is not riding in the vehicle 1. As described above, for example, the outside of the vehicle 1 is notified of the information by a travel-permission indicating lamp, an electric bulletin board, or the like provided on the outer side of the vehicle body 12. By this notification, the other person who is not riding in the vehicle 1 can recognize a fact that the vehicle 1 is traveling in the idle lane 103 after obtaining permission.

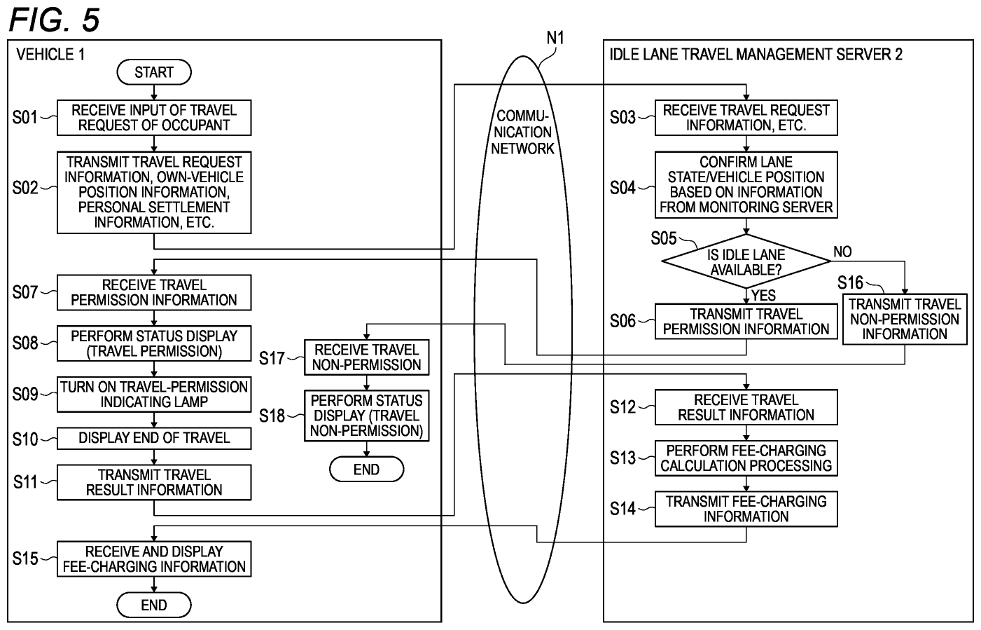

FIG. 5 is a flowchart illustrating an example of processing performed by the vehicle 1 and the server device 2 in a case where the occupant of the vehicle 1 requests to travel in the idle lane 103 (with reference to (4) travel request information described above).

The flowchart illustrated in FIG. 5 is different from the example illustrated in FIG. 2 in that fee-charging calculation processing for the vehicle 1 is incorporated into the flowchart. Hereinafter, a processing flow illustrated in FIG. 5 will be described with reference also to FIG. 2.

In step S01, a request to travel of the vehicle 1 is input to the input unit 112 of the automotive device 11. Then, in step S02, the transmission unit 113 transmits personal settlement information to the server device 2 in addition to (4) travel request information and (2) own-vehicle position information. The personal settlement information may be, for example, a credit card number, an ETC card ID, an ETC in-vehicle device ID, or authentication information related to carrier settlement of a mobile phone, account information of an existing WEB settlement service, or the like, but is not limited thereto.

In step S03, the reception unit 21 of the server device 2 receives the above-described information. In subsequent step S04, the processing unit 22 confirms a lane state/vehicle position based on information from the monitoring server device 3.

In subsequent step S05, the processing unit 22 performs determination whether the idle lane 103 is available for the vehicle 1. This determination may be similar to that described above with reference to FIGS. 1 to 4B. However, in step S05, the server device 2 also acquires the personal settlement information. Therefore, the processing unit 22 may perform permission/non-permission determination in consideration of the personal settlement information. For example, when the personal settlement information is a credit card number, the server device 2 may inquire of an external system whether the credit card number is valid. When the credit card number is not valid, the processing unit 22 may determine non-permission of traveling in the idle lane. However, a mode of determination by the processing unit 22 is not limited thereto.

Subsequent steps S06 to S15 in a case where the processing unit 22 determines travel permission for the vehicle 1 in step S05 will be described below. Thereafter, subsequent steps S16 to S18 in a case where the processing unit 22 determines travel non-permission will be described.

In step S06, the transmission unit 23 of the server device 2 transmits (5) travel permission information. In step S07, the reception unit 115 of the vehicle 1 receives the travel permission information. In step S08, the output unit 111 outputs the travel permission information to the occupant of the vehicle 1 (see FIG. 4A).

In step S09, the notification unit 121 of the vehicle body 12 performs notification for a person who is outside the vehicle 1 and who is not riding in the vehicle 1. For example, a travel-permission indicating lamp provided on the outer side of the vehicle body 12 is turned on.

The vehicle 1 that obtains travel permission performs lane change, and travels in the idle lane 103. The vehicle 1 whose travel in the idle lane 103 ends performs lane change again, and returns to the normal lane 101 or 102 (see FIG. 1). At this time, it can be seen from data of a probe provided in the vehicle 1, how much distance the vehicle 1 travels in the idle lane 103.

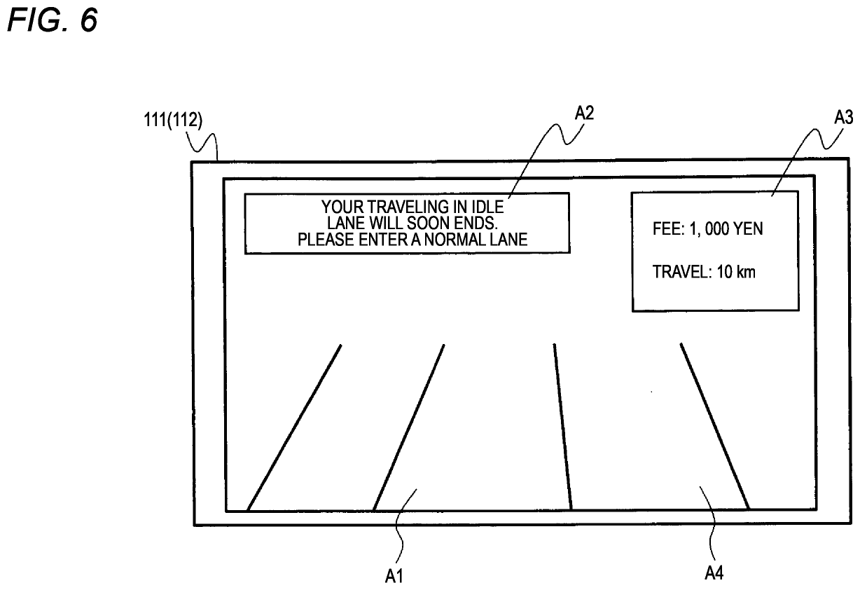

In step S10, the output unit 111 outputs information indicating an end of travel. FIG. 6 is a diagram illustrating an output example of the information. In the message box A2 displayed in a manner of being superimposed on the route information A1, a text message of “Your traveling in the idle lane will soon ends. Please travel in a normal lane” is displayed. At the fee display portion A3 on the upper right of the screen, a fee to be paid as a result of traveling in the idle lane 103 is displayed. However, in this example, since the fee is not settled at this time-point, a temporary amount is displayed. The idle lane 103 indicated by A4 returns to normal display without blinking, highlight display, or gray display. Note that this user interface is an example, and other output forms may be used. For example, an end of travel may be output by voice narration such as “Your traveling in the idle lane will soon ends. Please travel in a normal lane”.

In step S11, the transmission unit 113 transmits travel result information indicating a result of travel in the idle lane 103 to the server device 2. The travel result information contains information such as the personal settlement information described above and a travel distance covered by the vehicle 1 in the idle lane 103. The travel result information may contain the ID of the vehicle 1, the own-vehicle position information, and the like.

The reception unit 21 of the server device 2 receives the travel result information in step S12, and performs the fee-charging calculation processing under control of the processing unit 22 in step S13. The fee-charging calculation processing depends on what fee-charging method is adopted.

For example, when an ETC in-vehicle device ID is used, the transmission unit 113 may transmit a device number of an ETC in-vehicle device (not illustrated) provided in the vehicle 1 to the server device 2 as the personal settlement information in step S02 or step S11. The server device 2 may convert the device number into a user number under the control of the processing unit 22, and perform the fee-charging calculation processing using the user number. However, the above is merely an example, and other types of fee-charging calculation processing may be performed.

When the fee-charging calculation processing is completed, the transmission unit 23 transmits fee-charging information to the vehicle 1 in step S14. The fee-charging information may contain, for example, the personal settlement information described above, an amount of fee determined by settlement, and the like. In a case where a prepaid-type fee-charging method is adopted, the fee-charging information may contain an amount of balance after payment of the fee. However, the present disclosure is not limited to these exemplified modes, and appropriate information may be contained in the fee-charging information in accordance with the fee-charging method.

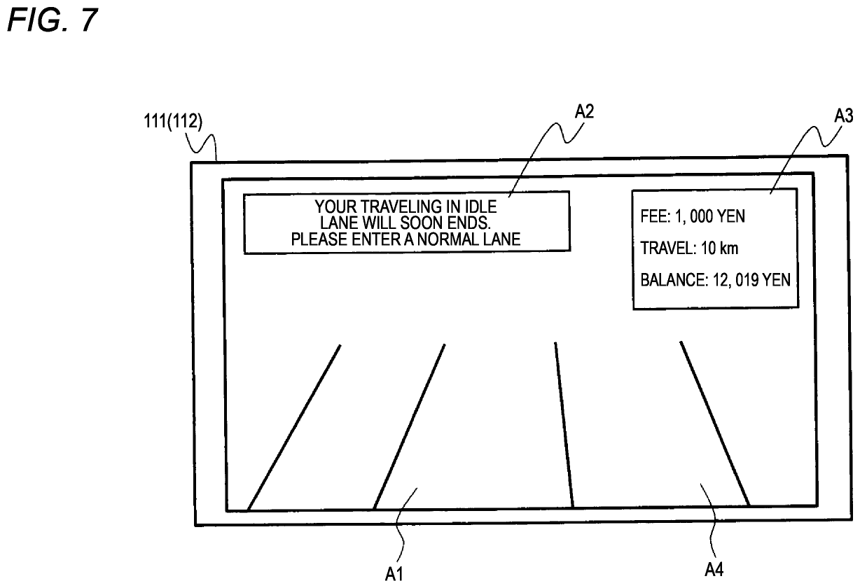

In step S15, the reception unit 115 of the vehicle 1 receives the fee-charging information. Then, the fee-charging information is output to the occupant via the output unit 111. FIG. 7 is a diagram illustrating an output example of the fee-charging information. The route information A1, the message box A2, and the idle lane 103 indicated by A4 are similar to those in FIG. 6. A final fee is displayed in a highlighted manner at the fee display portion A3 on the upper right of the screen. In the case of a prepaid-type fee-charging method, the amount of balance after payment of the fee may be displayed together. This user interface is an example, and the fee-charging information may be output in other forms. For example, the fee-charging information may be output by voice narration such as “The fee is xx yen. Please travel in a normal lane”.

Next, subsequent steps S16 to S18 in a case where the processing unit 22 determines travel non-permission for the vehicle 1 in step S05 described above will be described. In step S16, the transmission unit 23 of the server device 2 transmits (5) travel non-permission information to the vehicle 1. In step S17, the reception unit 115 of the vehicle 1 receives the travel non-permission information. In step S18, the output unit 111 outputs the travel non-permission information to the occupant of the vehicle 1 (see FIG. 4B).

Next, a modification of the fee-charging method will be described.

In the example described above, the pay-as-you-go fee-charging according to a distance covered in the idle lane 103 is exemplified as the fee-charging method. However, the fee-charging method is not limited thereto. For example, the fee-charging method may be a dynamic pricing method. This dynamic pricing is a method of adjusting the demand by varying the price according to a supply-demand situation. Since the idle lane is social capital (infrastructure), it is important to adjust the supply-demand balance of the infrastructure by some method. As an example, in the present disclosure, the balance adjustment is performed by dynamic fee variation.

The dynamic pricing fee-charging in the present disclosure may be implemented according to, for example, the number of receptions of travel request (4) received by the reception unit 21 of the server device 2 with respect to the idle lane 103 related to travel permission, and/or according to a congestion degree of the corresponding idle lane contained in (1) lane state/vehicle position information received by the reception unit 21.

As described above with reference to FIG. 2, (1) lane state/vehicle position information received by the server device 2 from the monitoring server device 3 contains congestion information indicating to what degree the lane is congested, information on a vehicle traveling in the lane (a current position of the vehicle, a vehicle type, and the like), and the like. Therefore, the server device 2 can recognize the congestion degree of the idle lane.

Further, as described above, the server device 2 can identify an idle lane in which the vehicle 1 is desired to travel, based on (2) own-vehicle position information, (4) travel request information, and the like received by the server device 2 from the vehicle 1.

Therefore, the server device 2 can recognize to what degree the idle lane, which is a target of a travel request, is congested at this moment. In addition, the server device 2 can recognize what magnitude of the number of travel requests concentrating in the idle lane. Accordingly, the server device 2 can perform dynamic pricing fee-charging based on these types of information. For example, the processing unit 22 may perform, as information processing, fee determinations such as increasing a fee when the idle lane is congested and increasing a fee when the travel requests for the idle lane are concentrated.

Information indicating a fee after increase determined by the processing unit 22 may be contained in (3) travel proposal information.

As another fee-charging method, the processing unit 22 may determine an amount to be charged based on information such as a vehicle type of the vehicle 1 that transmits the travel request information to the server device 2. For example, the fee may be reduced for a small vehicle or a vehicle complying with environmental regulations.

As another fee-charging method, there may be a fixed-fee method with a fixed fee amount. In the case of a fixed-fee method, it is not necessary to wait for a travel distance in the idle lane of the vehicle 1 to be determined. Therefore, the server device 2 may perform the fee-charging calculation processing (corresponding to step S13) at step S06 or the like in the flowchart illustrated in FIG. 5.

As described above, by management of the server device 2, the vehicle 1 can travel in the idle lane 103. Advantages presented at this time are in a wide variety as follows. First: congestion can be flexibly reduced or eliminated. Second: it is possible to meet the need for an occupant who wants to avoid congestion by paying a fee. Third: an administrator of the server device 2 can have a new source of income. Fourth: since the lane is social capital (infrastructure), it is possible to more effectively utilize this idle social capital.

In the above configuration, a server device may further include a transmission unit, and the transmission unit may transmit, to the vehicle, the travel permission/non-permission information indicating permission or non-permission of travel in the idle lane. According to the above configuration, permission or non-permission of travel in an idle lane for a vehicle can be grasped.

In the above configuration, when the vehicle, which is a transmission destination to which the transmission unit transmits travel permission information, travels in the idle lane related to the permission, the processing unit may perform fee-charging calculation processing for the vehicle. According to the above configuration, it is possible to manage a fee that traveling in an idle lane costs.

In the above configuration, fee-charging to be performed in the fee-charging calculation processing may be pay-as-you-go fee-charging in accordance with a travel distance of the vehicle in the idle lane related to the travel permission. The fee-charging to be performed in the fee-charging calculation processing may be dynamic pricing fee-charging implemented according to a number of receptions of travel request received by the reception unit with respect to the idle lane related to the travel permission, and/or according to a congestion degree of the idle lane contained in lane state/vehicle position information of an idle lane received by the reception unit. According to the above configuration, it is possible to flexibly adjust a fee that traveling in an idle lane costs, based on a travel distance of a vehicle, infrastructure information, and the like.

In the above configuration, when information indicating that an emergency vehicle is present on the idle lane related to the travel request is contained in the lane state/vehicle position information of the idle lane received by the reception unit, the processing unit may determine non-permission of traveling in the idle lane for the vehicle. According to the above configuration, it is possible to avoid a situation in which a vehicle that is going to travel in an idle lane hinders traveling of an emergency vehicle having a high priority.

In the above configuration, when information, which indicates that there is an object on the idle lane related to the travel request that hinders vehicle passage, is contained in the lane state/vehicle position information of the idle lane received by the reception unit, the processing unit may determine non-permission of traveling in the idle lane for the vehicle. According to the above configuration, it is possible to permit travel in an idle lane only when safe passage of a vehicle is possible. Therefore, a vehicle can safely travel in an idle lane.

In addition, in a server device including a reception unit and a processing unit, a travel management method for managing idle lane travel of a vehicle may include: a step of causing the reception unit to receive lane state/vehicle position information of an idle lane via a communication network; a step of causing the reception unit to receive own-vehicle position information of a vehicle via a communication network; a step of causing the reception unit to receive a travel request of the idle lane from the vehicle via a communication network; and a step of, in response to the travel request, causing the processing unit to determine whether traveling in the idle lane is available to the vehicle based on the own-vehicle position information of the vehicle and the lane state/vehicle position information of the idle lane. According to the above configuration, it is possible to manage idle lane travel of a vehicle.

In addition, a travel management program for managing idle lane travel of a vehicle may cause a server device including a reception unit and a processing unit to execute:

a step of causing the reception unit to receive lane state/vehicle position information of an idle lane via a communication network; a step of causing the reception unit to receive own-vehicle position information of a vehicle via a communication network; a step of causing the reception unit to receive a travel request of the idle lane from the vehicle via a communication network; and a step of, in response to the travel request, causing the processing unit to determine whether traveling in the idle lane is available to the vehicle based on the own-vehicle position information of the vehicle and the lane state/vehicle position information of the idle lane. According to the above configuration, the server can manage idle lane travel of a vehicle.

In addition, an automotive device to be mounted on a vehicle may include a reception unit and an output unit, in which when the reception unit receives travel proposal information for an idle lane via a communication network, the output unit may output the travel proposal information for the idle lane to an occupant of the vehicle. According to the above configuration, an occupant of a vehicle can receive a travel proposal for an idle lane.

In the above configuration, when the reception unit receives travel permission/non-permission information of the idle lane via a communication network, the output unit may output the travel permission/non-permission information of the idle lane to the occupant of the vehicle. According to the above configuration, an occupant of a vehicle can appropriately grasp permission/non-permission of idle lane travel.

In the above configuration, when the reception unit receives travel permission information of the idle lane via a communication network, the output unit may output the travel permission information of the idle lane to a notification unit provided in the vehicle. According to the above configuration, it is possible to notify an outside that a vehicle on which the automotive device is mounted obtains travel permission of an idle lane.

Although various embodiments are described above with reference to the drawings, it is needless to say that the present disclosure is not limited to such examples. It will be apparent to those skilled in the art that various changes and modifications may be conceived within the scope of the claims. It is also understood that the various changes and modifications belong to the technical scope of the present disclosure. Further, components in the above-described embodiments may be combined freely within a range not departing from the spirit of the present disclosure.

The present application is based on Japanese Patent Application No. 2019-048931 filed on Mar. 15, 2019, the contents of which are incorporated herein by reference.

The present disclosure can be applied to a system that makes it possible to use an idle lane. The vehicle 1 exemplified above can communicate with the server device 2 and the like via a communication network. Under a condition that such a constantly connected moving body is widely used in society and a lane manager can grasp a traveling path thereof in real time based on probe data or the like of the vehicle, it is possible to more effectively utilize a lane that is idle social capital. For example, a lane that is not used by a general vehicle (including a dedicated passage zone of a general road, a road side strip of a highway, and the like) may also be interpreted as a temporarily-available idle lane in the future as long as the condition is satisfied. However, it is obvious that safety of traffic, compliance of law, and the like are prioritized.

1. A server device comprising:
a receiver; and
a processor,
wherein the receiver is configured to receive lane state/vehicle position information of an idle lane via a first communication network,
wherein the receiver is configured to receive own-vehicle position information of a vehicle via a second communication network,
wherein the receiver is configured to receive a travel request for the idle lane from the vehicle via a third communication network, and
wherein in response to the travel request, the processor determines whether traveling in the idle lane is available to the vehicle, based on the own-vehicle position information of the vehicle and the lane state/vehicle position information of the idle lane.

2. The server device according to claim 1, further comprising:
a transmitter,
wherein the transmitter transmits travel permission/non-permission information to the vehicle, the travel permission/non-permission information indicating permission or non-permission of traveling in the idle lane.

3. The server device according to claim 2,
wherein in a case in which the vehicle, which is a transmission destination to which the transmitter transmits travel permission information, travels in the idle lane related to the permission, the processor performs fee-charging calculation processing for the vehicle.

4. The server device according to claim 3,
wherein fee-charging to be performed in the fee-charging calculation processing is pay-as-you-go fee-charging in accordance with a travel distance of the vehicle in the idle lane related to the travel permission.

5. The server device according to claim 3,
wherein fee-charging to be performed in the fee-charging calculation processing is dynamic pricing fee-charging implemented according to a number of receptions of travel requests received by the receiver with respect to the idle lane related to the travel permission, and/or according to a congestion degree of the idle lane contained in the lane state/vehicle position information of the idle lane received by the receiver.

6. The server device according to claim 2,
wherein the lane state/vehicle position information comprises a congestion information on each lane, and
wherein in a case where the processor determines that the vehicle travels under congestion, the processor starts a determination processing of permission or non-permission of traveling in the idle lane.

7. The server device according to claim 2,
wherein in a case in which the processor determines that traveling in the idle lane is available to the vehicle, the transmitter transmits travel proposal information to the vehicle.

8. The server device according to claim 7,
wherein the travel proposal information comprises information identifying the idle lane and information on an allowed travel distance or travel time.

9. The server device according to claim 1,
wherein in a case in which information indicating that an emergency vehicle is present on the idle lane related to the travel request is contained in the lane state/vehicle position information of the idle lane received by the receiver, the processor determines that traveling in the idle lane for the vehicle is not permitted.

10. The server device according to claim 1,
wherein in a case in which information indicating that there is an object hindering vehicle passage on the idle lane related to the travel request that hinders vehicle passage is contained in the lane state/vehicle position information of the idle lane received by the receiver, the processor determines that traveling in the idle lane for the vehicle is not permitted.

11. The server device according to claim 1,
wherein in a case in which information indicating a type of vehicle to which the idle lane related to the travel request is available, the processor determines that traveling in the idle lane for the vehicle is not permitted if the vehicle does not belong to the type of vehicle.

12. The server device according to claim 1,
wherein the second communication network is a communication network common to the third communication network.

13. The server device according to claim 12,
wherein the first communication network is a communication network different from the second communication network and the third communication network.

14. The server device according to claim 1,
wherein the first communication network, the second communication network and the third communication network are common to one another.

15. The server device according to claim 1,
wherein the processor is configured to identify a current position of the vehicle based on the own-vehicle position information, and determine whether a lane near the current position is the idle lane available to the vehicle based on the lane state/vehicle position information.

16. A travel management method in a server device for managing idle lane travel of a vehicle, the server device comprising a receiver and a processor,
the travel management method comprising:
receiving, by the receiver, lane state/vehicle position information of an idle lane via a communication network;
receiving, by the receiver, own-vehicle position information of a vehicle via a communication network;
receiving, by the receiver, a travel request for the idle lane from the vehicle via a communication network; and
causing, in response to the travel request, the processor to determine whether traveling in the idle lane is available to the vehicle, based on the own-vehicle position information of the vehicle and the lane state/vehicle position information of the idle lane.

17. A non-transitory computer-readable medium storing a travel management program for managing idle lane travel of a vehicle, the travel management program that, when executed by a processor of a server device comprising a receiver and the processor, causes the server device to perform operations comprising:
receiving lane state/vehicle position information of an idle lane via a communication network;
receiving own-vehicle position information of a vehicle via a communication network;
receiving a travel request for the idle lane from the vehicle via a communication network; and
determining, in response to the travel request, whether traveling in the idle lane is available to the vehicle, based on the own-vehicle position information of the vehicle and the lane state/vehicle position information of the idle lane.

18. An automotive device to be mounted on a vehicle, the automotive device comprising:
a receiver; and
an output device,
wherein in a case in which the receiver receives travel proposal information for an idle lane via a communication network, the output device outputs the travel proposal information for the idle lane to an occupant of the vehicle.

19. The automotive device according to claim 18,
wherein in a case in which the receiver receives travel permission/non-permission information of the idle lane via a communication network, the output device outputs the travel permission/non-permission information of the idle lane to the occupant of the vehicle.

20. The automotive device according to claim 19,
wherein in a case in which the receiver receives travel permission information of the idle lane via a communication network, the output device outputs the travel permission information of the idle lane to a notification device provided in the vehicle.
